(19) United States
(12) Patent Application Publication
(10) Pub. No.: US 2025/0300925 A1
(43) Pub. Date: Sep. 25, 2025

(54) DECLARATIVE DIGITAL TWINS

(71) Applicant: Cirrus360 LLC, Richardson, TX (US)

(72) Inventors: Alan Gatherer, Dallas, TX (US); Chaitali Sengupta, Richardson, TX (US); Sudipta Sen, Richardson, TX (US)

(21) Appl. No.: 19/086,306

(22) Filed: Mar. 21, 2025

Related U.S. Application Data
(60) Provisional application No. 63/568,795, filed on Mar. 22, 2024.

(51) Int. Cl. H04L 43/55; H04L 41/0866

(52) U.S. Cl. CPC H04L 43/55; H04L 41/0866

(57) ABSTRACT

A method for using a declarative digital twin approach to facilitate integration and deployment in radio access networks (RANs) is provided. The method includes receiving declarations describing one or more components in the RAN. The method includes generating a declarative model of the RAN based on the declarations, the declarative model comprising a plurality of constraints. The method includes performing an analysis on the declarative model including reasoning about the plurality of constraints. The method further includes identifying a solution for the RAN based on the analysis of the declarative model. The method further includes providing the solution including, for example, relevant constraints and insights explaining the aspects of the solution.

### CROSS-REFERENCE TO RELATED APPLICATIONS

The present disclosure is related and claims priority, under 35 U.S.C. § 119(e), to U.S. Provisional Patent Application No. 63/568,795, entitled DIGITAL TWINS FOR TESTING RADIO ACCESS NETWORKS to Alan Gatherer, et-al., filed on Mar. 22, 2024, the contents of which are hereby incorporated by reference in its entirety, for all purposes.

### TECHNICAL FIELD

The present disclosure generally relates to generating declarative digital twins using declarations that define constraints/rules for units in a system to follow. More specifically, the present disclosure is directed to a domain specific language driven methodology to construct a declarative digital twin that may be used for modeling different stages of a continuous integration (CI) loop in a deployment lifecycle within a physical system.

### BACKGROUND

Digital twins are high-fidelity digital representations of physical components and systems. Digital twins can be utilized to simulate, monitor, and optimize the performance of a system and can be leveraged to, for example, simplify testing in the system by mimicking the physical components therein. A traditional digital twin merely provides an output and lacks explanations for why the results are as they are. Improving testing mechanisms is increasingly important for maintaining operational efficiency, user satisfaction, and gaining operational insights within the network environment.

### SUMMARY

The present disclosure is directed to systems, methods, and machine-readable media for using a declarative digital twin approach to facilitate integration and deployment in radio access networks (RANs). The method includes generating a declarative digital twin based on hardware, function, and system constraints provided for the RAN. The declarative digital twin is designed to model the system and plan, analyze, build, test, and/or deploy the system.

A method for using a declarative digital twin approach to facilitate integration and deployment in RANs is provided. The method includes receiving declarations describing one or more components in the RAN. The method includes generating a declarative model of the RAN based on the declarations, the declarative model comprising a plurality of constraints. The method includes performing an analysis on the declarative model including reasoning about the plurality of constraints. The method further includes identifying a solution for the RAN based on the analysis of the declarative model. The method further includes providing the solution including, for example, relevant constraints and insights explaining the aspects of the solution.

According to one embodiment of the present disclosure, a system is provided including a processor and a memory comprising instructions stored thereon, which when executed by the processor, causes the processor to perform a method for facilitating integration and deployment. The method includes receiving declarations describing one or more components in a RAN. The method also includes generating a declarative model of the RAN based on the declarations, the declarative model comprising a plurality of constraints. The method also includes performing an analysis on the declarative model including reasoning about the plurality of constraints. The method also includes identifying a solution for the RAN based on the analysis of the declarative model. The method also includes providing the solution to a user of the RAN.

According to one embodiment of the present disclosure, a non-transitory computer-readable storage medium is provided including instructions (for example, stored sequences of instructions) that, when executed by a processor, cause the processor to perform a method for facilitating integration and deployment. The method includes receiving declarations describing one or more components in a RAN. The method also includes generating a declarative model of the RAN based on the declarations, the declarative model comprising a plurality of constraints. The method also includes performing an analysis on the declarative model including reasoning about the plurality of constraints. The method also includes identifying a solution for the RAN based on the analysis of the declarative model. The method also includes providing the solution to a user of the RAN.

According to one embodiment of the present disclosure, a system is provided that includes means for storing instructions, and means for executing the stored instructions that, when executed by the means, cause the means to perform a method for facilitating integration and deployment. The method includes receiving declarations describing one or more components in a RAN. The method also includes generating a declarative model of the RAN based on the declarations, the declarative model comprising a plurality of constraints. The method also includes performing an analysis on the declarative model including reasoning about the plurality of constraints. The method also includes identifying a solution for the RAN based on the analysis of the declarative model. The method also includes providing the solution to a user of the RAN.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To easily identify the discussion of any particular element or act, the most significant digit or digits in a reference number refer to the figure number in which that element is first introduced.

FIG. 1 illustrates a network architecture used for implementing RAN security techniques, as described herein.

FIG. 2 is a block diagram illustrating details of devices used in the architecture, according to certain aspects of the present disclosure.

FIG. 3 is an example illustration of a system architecture implementing a declarative digital twin approach for continuous integration and continuous deployment (CICD) in a system, according to certain aspects of the present disclosure.

FIG. 4 illustrates an example flow diagram for facilitating integration and deployment in RANs, according to certain aspects of the present disclosure.

FIG. 5 is a block diagram illustrating an example computer system (for example, representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Testing systems, particularly for complex deployments like Radio Access Networks (RAN), are crucial for ensuring reliability, performance, and interoperability in a modern telecommunications infrastructure. Component testing can be challenging in physical systems in general due to the high flexibility in protocol implementations. For example, in a RAN, the need for tight synchronization with radio units (RUs), multi-vendor environments, deployment issues, etc., make testing, as well as other stages in CI of the RAN, a challenge. Testing may also be required frequently to ensure seamless operations throughout the system. For example, continuous updates for different software and firmware, along with configuration updates, may necessitate repeated testing of open distributed units (O-DUs), which increases cost (for example, costs associated with directly performing testing and storage costs) and consumes a lot of time.

Digital twin simulations have emerged as a powerful tool in this context, offering a virtual representation of physical systems for comprehensive testing and validation. Despite their benefits, digital twin simulations face several challenges such as accurately representing real-world conditions and system interactions, validation issues for artificial intelligence and machine learning (AI/ML)-based models, and data integration complexities.

Digital twins may be used in the continuous integration (CI) loop for simulating the physical system operations or model-based testing of heterogeneous systems before implementation. However, digital twins are merely a simulation of a physical system and provide an output that mimics the behavior of a physical system and lacks explanations for why the results are as they are, failing to provide beneficial insights unbeknownst to a user. Thus, meaning must be derived from an output using additional analysis to understand the operation or reasoning for the outputs of a real system as represented by the digital twin. This limits a user's ability to explore and get answers to, for example, what may be causing a failure in the real system, limiting the overall capabilities and applicability of the digital twin.

Embodiments of the present disclosure address the above identified problems using a Domain Specific Language (DSL) driven methodology to construct a declarative digital twin for modeling the lifecycle of a physical system and leveraging reasoning tools to derive meaningful insights and solutions for the physical system. It is also understood that the present disclosure may be applied to any real-time or periodic systems including, for example, RANs running on a hardware processing platform, or the like.

The subject disclosure further addresses the above-described problems by providing for systems, methods, and machine-readable media for generating declarative digital twins as a high-fidelity digital representation of a physical system (for example, a RAN) or system components (for example, an RU). According to embodiments, the declarative digital twin is generated as a repository of declarations, constraints, facts, and rules that the physical system needs to obey. The declarative digital twin may include precise descriptions of what one or more physical components being modeled must do. By non-limiting example, the declaration may define timing constraints such as start and/or end times for functions or physical constraints such as points in the system where functions are run. Implementing the declarative digital twin to perform system testing generates a simpler, more compact, and faster model of the system. The declarative digital twin enables users to, for example, analyze network behavior, predict failures, optimize configurations, and improve overall network efficiency. According to embodiments, a constraint solver may be configured to generate insights on the physical system based on the declarative statements of the declarative digital twin. That is, the constraint solver may answer what-if and how-to questions about the system by reasoning about the repository of facts and constraints. According to embodiments, the constraint solver may use AI reasoning on the declarative digital twin to automate all stages of the CI loop. Using techniques like satisfiability (SAT) solvers (for example, including a satisfiability modulo theorem or SMT solvers) on the declarative digital twin to analyze a system allows the constraint solver to reason about the system and find answers to questions a user trying to, for example, build, integrate, or test the system may ask.

In some implementations, the declarative digital twin and/or solutions from the constraint solver may be used to build a simulation of the system and test the system. In some implementations, the constraint solver may determine, based on the declarative digital twin representing constraints on one or more components in a system, whether the constraints are a feasible solution for the system. In some implementations, the constraint solver may determine one or more constraints that need to be true (or similarly, not true) for the digital twin to be a feasible solution to the system. In some implementations, the declarative digital twin is used to describe if the system will pass or fail and why it will pass or fail using the constraint solver, providing a richer result that includes an explanation for pass/fail predictions. The solver may search the test space to find the inputs that produce failure using one or more known analysis techniques.

According to embodiments, the declarative digital twin may be queried (via, for example, a user interface) for information about the system to gain insight based on the declared constraints and AI reasoning. Therefore, the declarative digital twin may be used to observe a real system but also derive better solutions based on logic. By non-limiting example, a user may query the declarative digital twin to determine a lowest power necessary for running a physical object x in a corresponding real system y. This is advantageous over traditional digital twins, which provide outputs without explanation or reasoning for the provided output, because the user can gain insights and discover solutions. Further, a traditional digital twin may not predict failure unless it is given the right input stimulus for failure, which is usually unknown for a given system.

According to embodiments, DSL and one or more constraints captured into a repository (or data lake) including an abstract hardware description may be used to create the declarative digital twin. With DSL (for example, RAN DSL), the declarative digital twin provides a logical description of a space within which the system can operate, rather than a “mimic” of the system that requires input to get insight, making the declarative digital twin uniquely different to the traditional conception of a digital twin. Further, the declarative and descriptive approach to generating a digital twin enables the ability to input abstract, high level, and/or approximate constraints and still produce valid insights into the operation of the system.

According to embodiments, inputs and outputs are consumed in the declarative digital twin as the metadata that describes constraints on the input data applied and, by implication, the constraints required on the output data of a system. If input data is given in its raw form, then it can be mathematically translated into input constraints. The resulting output constraints, based on the input constraints, implied by the declarative digital twin, can be checked against actual system output data. Therefore, test data from the declarative digital twin is compact for storage as it only describes constraints on the input data as metadata, rather than storing raw data from the system. In some implementations, the actual data for the real system can be generated based on the constraints applied (for example, by a generation program) when the system is compared to the declarative digital twin.

The disclosed declarative digital twin addresses limitations in system modeling, specifically targeting technical problems associated with analyzing, building, testing, and refining system deployments. The declarative design of the digital twin allows for many possible systems to be modeled by a same declarative digital twin because the digital twin specifies the required constraints on operations. The declarative digital twin specifies what should happen rather than simulates what does happen. Therefore, the declarative digital twin defines a subspace of possible systems that are all valid. The declarative digital twin is capable of generating many possible diverse scenarios and systems, all of which are valid from the system point of view. The declarative digital twin optimizes system performance by direct manipulation of relevant operational constraints.

According to embodiments, the declarative digital twin can be a mixture of operational constraints that are observed in the actual system, and those that are defined from understanding of the correct operation of the system, such as those derived from, for example, laws of physics for instance, or from known limits on input parameters. As such, using the DSL-based declarative digital twin, any output and meaning is intrinsic to the results. The digital twin is capable of simulating diverse scenarios and optimizing system performance based on critical operational constraints.

Several implementations are discussed below in more detail in reference to the figures.

### Example Architecture

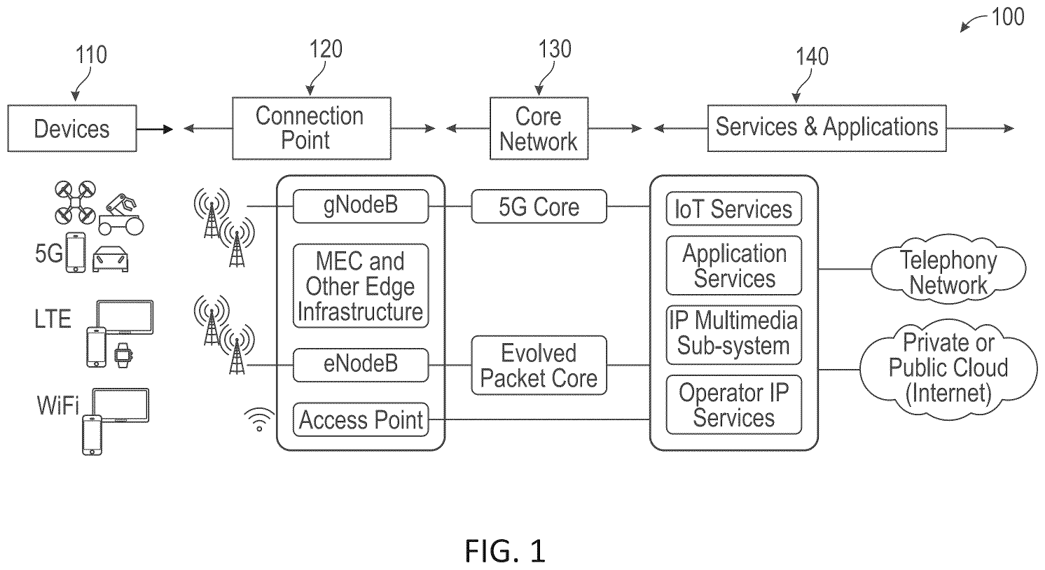

FIG. 1 illustrates an exemplary telecommunications infrastructure 100, according to certain aspects of the present disclosure. The telecommunications infrastructure 100 may include multiple devices 110 communicatively coupled to a connection point 120. For example, the devices 110 may include 5G/LTE/Wi-Fi/IoT enabled devices including, but not limited to, drones, smart cars, smart phones, smart televisions, smart watches, other smart devices, and the like. In an implementation, the connection point 120 may include, for example, RAN, ORAN, 5G, Wi-Fi, gNodeBs, eNodeBs, Multi-Access Edge Computing (MEC) and other edge infrastructures, access points, and the like.

The connection point 120 may be communicatively coupled to a core network 130. For example, the core network 130 may include a 5G core network, an evolved packet core network, and the like. The core network 130 may be communicatively coupled to multiple services and applications 140. For example, the services and applications 140 may be housed on various internet servers for IoT services, applications, IP multimedia sub-systems, operator/user IP services, and the like. The servers may be coupled to a telephony network, private or public cloud, the Internet, etc.

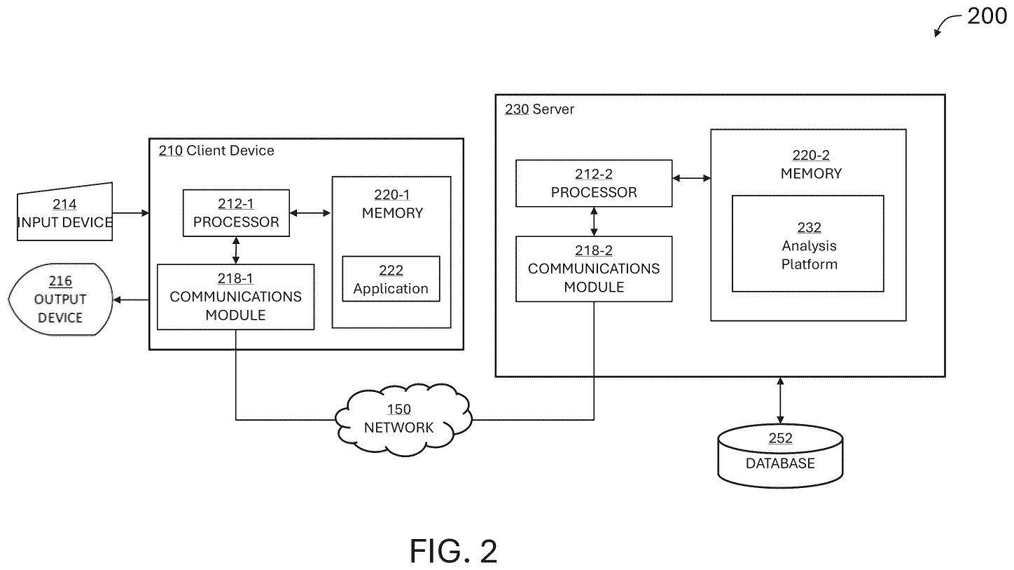

FIG. 2 is a block diagram 200 illustrating details of a client device 210 and a server 230 used in a network architecture as disclosed herein (for example, telecommunications infrastructure 100), according to some embodiments. Client device 210 (for example, at least one of devices 110) and server 230 (for example, hosting services and applications 140) are communicatively coupled over network 150 (for example, connection point 120) via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (for example, via electromagnetic radiation, such as radiofrequency—RF—, near field communications—NFC—, Wi-Fi, and Bluetooth radio technology).

Client device 210 may be coupled with an input device 214 and with an output device 216. A user may interact with client device 210 via the input device 214 and the output device 216. Input device 214 may include a mouse, a keyboard, a pointer, a touchscreen, a microphone, a joystick, a virtual joystick, a touch-screen display that a user may use to interact with client device 210, or the like. In some embodiments, input device 214 may include cameras, microphones, and sensors, such as touch sensors, acoustic sensors, inertial motion units—IMUs—and other sensors configured to provide input data to a secondary device. Output device 216 may be a screen display, a touchscreen, a speaker, and the like.

Client device 210 may also include a processor 212-1, configured to execute instructions stored in a memory 220-1, and to cause client device 210 to perform at least some operations in methods consistent with the present disclosure. Memory 220-1 may further include an application 222, configured to run in client device 210 and couple with input device 214 and output device 216. The application 222 may include specific instructions which, when executed by processor 212-1, cause operations to be performed according to methods described herein. Application 222 may receive data from the server 230 and may be hosted by the server 230. In some embodiments, the application 222 runs on an operating system (OS) installed in client device 210. In some embodiments, application 222 may run out of a web browser. In some embodiments, the processor is configured to control a graphical user interface (GUI) for the user of one of client devices 210 accessing the server 230.

A database 252 may store data and files associated with the client device 210 and/or server 230. In some embodiments, client device 210 is a mobile phone used to initiate communication to another client device or server 230. Related data of the communication may be stored at the database 252.

Server 230 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an analysis and automation platform 232 (hereafter simply referred to as “analysis platform”). The analysis platform 232 may be configured to perform operations and methods according to aspects of embodiments. The analysis platform 232 may share or provide features and resources with the client device, including multiple tools associated with the transfer or receipt of communications with, for example, application 222. The user may access analysis platform 232 through application 222, installed in a memory 220-1 of client device 210. Accordingly, application 222 may comprise a user portal or the like. The application 222 may be installed from server 230 and perform scripts and other routines provided by server 230 through any one or more of multiple tools. Execution of application 222 may be controlled by processor 212-1.

The analysis platform 232 may be accessible to users as a service. The analysis platform 232 may be a cloud-based platform. In some embodiments, the analysis platform 232 may comprise a digital twin component configured to generate a declarative digital twin based on, for example, domain specific constraints and functions of system components. In some embodiments, the analysis platform 232 is an intent-driven, domain specific, RAN automation platform configured to orchestrate and manage RAN deployments, including network planning, configuration, and optimization, implementing a declarative digital twin approach to testing, for example, O-RAN DUs, RUs, and/or CUs described according to one or more embodiments. The analysis platform 232 may include or be communicatively coupled to a SAT solver configured to reason about feasible implementations/solutions for a system using artificial intelligence (AI) reasoning based on a set of constraints. The analysis platform 232 may include or be communicatively coupled to a refinement model configured to improve the modeling of a system over time based on deployment results, new constraint in the system, or the like.

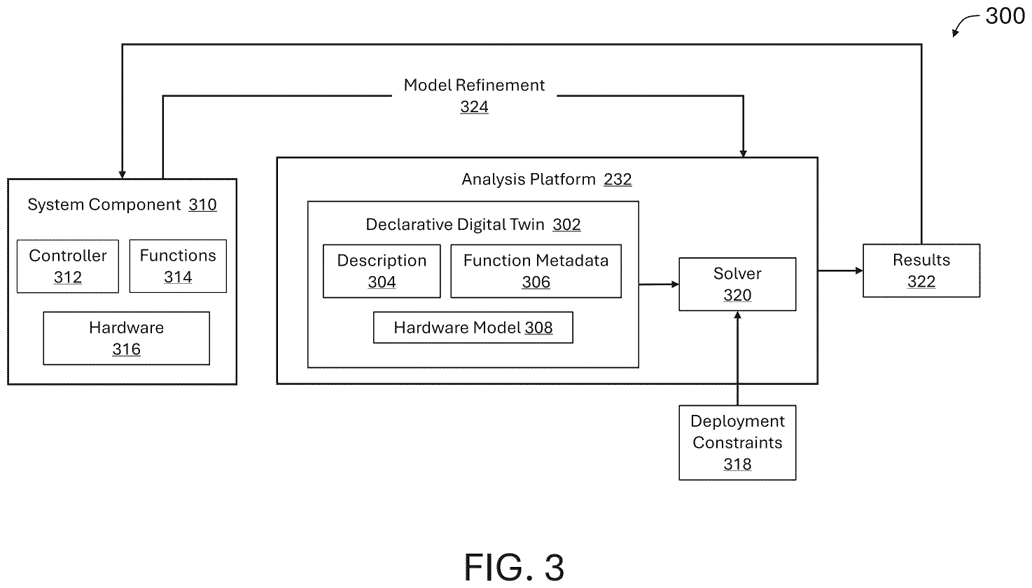

FIG. 3 illustrates an exemplary system architecture 300 implementing a declarative digital twin approach for continuous integration and continuous deployment (CICD) in a system, according to certain aspects of embodiments. The system may include any hardware-software system (for example, RAN) or a real-time processing system, designed to receive inputs, process these inputs, and generate corresponding outputs. In some implementations, the processing of inputs may be executed periodically and within a predefined time frame to ensure timely and accurate responses (that is, period real-time systems). The system architecture 300 may include a system component 310, an analysis platform 232 including a declarative digital twin 302, and solver 320. The system architecture 300 may support the disaggregation of hardware and software components through the use of virtualized network functions (VNFs) and the analysis platform 232.

The system component 310 may include one or more physical devices, computing devices, a processor, or the like, in a system. For example, the system component 310 may include a RAN component such as an RU, DU, and/or CU leveraging O-RAN hardware and software supported through the analysis platform 232 to enable a more flexible, multi-vendor deployment model. The system component 310 (for example, a DU) may process data from user equipment (UE) and communicate with one or more other system components (for example, CU). The system component 310 may comprise a controller 312 (for example, a RAN Intelligent Controller (RIC)), a set of hardware and/or software functions 314 (for example, 5G RAN functions), and physical hardware 316 (for example, RAN DU hardware). The controller 312 may enable near-real-time or on-real-time control and optimization of RAN elements and resources. The functions 314 may have a set of potential patterns that describe how data moves through the hardware 316 once the data has been created by the function 314. The patterns are properties of the hardware 316, and each function has the set of potential patterns it can use. The functions 314 serve as a way to describe data management in the hardware 316 in a declarative manner.

The declarative digital twin 302 may be a machine-readable data lake of facts and constraints generated by the analysis platform, producing a logical description of a space within which a system (for example, including system component 310) can operate. As such, the declarative digital twin 302 allows many possible systems to be modeled by the same digital twin by only modelling the required constraints on operation, not assumed constraints or patterns. The declarative digital twin 302 provides a simpler, more compact, and faster model for testing the system. The declarative digital twin 302 may include function metadata 306 describing the set of possible software and hardware components that can be used to implement function 314 in the system. In some implementations, the function metadata 306 may be described using YAML format about RAN functions including, but not limited to, runtime, memory sizes, etc. The hardware model 308 may model the physical hardware 316 as a set of functions based on function metadata 306. The declarative digital twin 302 may be deployed for running a test on a system based on the constraints and reasoned about using the analysis platform 232.

Descriptions 304 may include a data lake of facts and constraints on how the functions 314 can connect together in the system component 310. The descriptions 304 make up the declarative digital twin 302, modeling aspects of the system component 310. The constraints may be described in a programmable language (for example, DSL) and implemented in the system component 310. In some embodiments, the descriptions 304 include declarations which are converted into the data lake of constraints. The descriptions 304 may include conditions for implementing tasks or dependencies between different tasks within the system component 310. The descriptions 304 may be expressed as mathematical expressions, functions, Boolean decisions, linear inequalities (for example, maximum transmit power, minimum signal-to-noise ratio), equalities (for example, resource allocation balance), or the like.

According to embodiments, the inputs of the declarative digital twin 302 may be consumed as metadata that describes the constraints on the input data applied and, by implication, the constraints required on the output data. As a result, the test data can be more compact for storage as it only describes constraints on the input data. In some implementations, the input data may be given in its raw form. Then, the declarative digital twin 302 may be configured to mathematically translate the raw data into constraints. Accordingly, the resulting output constraints implied by the declarative digital twin 302 can be checked against the actual system output data. Actual data for the system component 310, if needed to be generated, may be done with the constraints applied by a generation program when comparing the system to the declarative digital twin 302.

According to embodiments, descriptions 304 may include hardware constraints that declaratively describe the hardware 316 which become hardware declarations that the analysis platform 232 can use to reason about how the system component 310 will run under the conditions presented in the descriptions 304. In some implementations, the descriptions 304 may include a declarative description of the hardware 316 using, for example, YAML and/or XML. The YAML format may capture hardware resources and patterns of data movement through the hardware 316.

In some implementations, the hardware 316 may be constrained by hardware abstractions that define logical descriptions of how system component 310 behaves. Hardware model 308 may include hardware declarations including, but not limited to, amount of memory, number of CPUs, or the like. By non-limiting example, the descriptions 304 may include memory usage conditions described as a threshold minimum, maximum, or range. As another non-limiting example, the descriptions 304 may include declarations of flows running through the system (e.g., description of physical connections between memories and CPUs). RDSL may be used to capture dependencies between functions and flows. In some implementations, a plurality of flows in a single piece of hardware may be declared independent of each other.

In some implementations, hardware model 308 may also include patterns associated with the function metadata 306. The patterns in hardware model 308 may be associated with other hardware components (for example, memory, compute elements, interfaces, etc.) to show how the pattern uses hardware 316. The patterns may also contain temporal constraints including, for example, indicating how quickly data can move through the hardware, to complement the runtime constraints in the function metadata 306. For testing, the hardware model 308 may also include constraints on how functions are processed by middleware of the hardware 316, such as an operating system or a scheduler. This may comprehend the constraints on operation and timing of an opportunistic scheduler, for instance.

According to embodiments, deployment constraints 318 may include declarations provided by a user of the system or an enterprise (e.g., administrator, deployment operator, or the like). The deployment constraints 318 may include system level declarations about, for example, timing, power security, traffic models like number of users/QoS classes, target latency, resource reservations, bandwidth allocation, power requirements, or other network requirement declarations input by the user or entity in the enterprise space who wants to implement, for example, a RAN in the system. YAML format may be used to capture deployment constraints 318. According to embodiments, declarations are not limited to strict requirements and may include design consideration or optional features. By non-limiting example, the user may relax the latency requirement, allowing for more diverse solutions to the system.

According to embodiments, the analysis platform 232 may be communicatively coupled with a user interface (UI) designed to facilitate natural language interactions between the analysis platform 232 and the user. The UI may accept natural language and/or human generated descriptions of the system component 310 (e.g., deployment constraints 318). The analysis platform 232 may interpret the conversational request and generate a set of declarative constraints which may be included in the descriptions 304.

The analysis platform 232 may include a solver 320 configured to apply reasoning techniques to the declarative digital twin to reason about how the physical system will work under the provided conditions (that is, descriptions 304 and deployment constraints 318). The system component 310 may include a growing list of hundreds and thousands of constraints over time, resulting in a complex problem for testing. The analysis platform 232 may use the solver 320 to identify feasible solutions to the system during testing given all the constraints. The solver 320 may include a satisfiability modular theorem (SMT) solver, a SAT solver, or the like, using logical reasoning to determine whether a set of logical constraints defined by the declarative digital twin can be satisfied.

The solver 320 is built into the analysis platform 232 to analyze inputs and reason with the declarative digital twin 302 to determine feasibility of the provided constraints. The solver 320 may determine a subset of constraints relevant to an identified feasible solution. According to embodiments, the feasible solution is not limited to solutions that result in a passing test. For example, the solution may include constraints or a set of constraints that represent the conditions under which a test on the system will fail and reasons for the failure based on an analysis of the declarative digital twin.

As described, the solver 320 may identity examples of failures, reasons behind failures, and provide insights based therefrom. According to embodiments, the insights may be provided as declarations in a human readable format. The analysis platform 232 may leverage machine learning or natural language processing techniques, such as a large language model (LLM), to generate a description of the solution (for example, the constraints causing a pass or fail) and the insights identified based on the solutions (for example, reasons and examples to support why the system would pass or fail based on the constraints).

The solver 320 may use the declarative digital twin 302 to identify and describe if the system component 310 will pass or fail and why it will pass or fail, using AI reasoning to provide a richer response that includes explanations. In some embodiments, for RAN testing, the solver 320 may search through a test space using AI reasoning (for example, SAT solvers). The test space may relate to the hardware platform (that is, the system component 310) as well as the deployment of the hardware system. For example, the solver 320 may determine feasibility by solving for an example within the system by searching for a solution based on implementation of the constraints. The example may be used as a proof of the feasibility of the solution. In some implementations, solver 320 may apply AI learning or generative AI on the declarative digital twin to identify solutions to the system.

The AI reasoning abilities of the solver 320 provides users with not only where the system may fail, but also provides insights on why it will fail. The insights may be provided to users as a description of the implementation. Accordingly, the analysis platform 232 may take a relevant subset of constraints to generate a higher level human understandable insight that may be provided to users. In some embodiments, the description of the implementation may be output by the solver 320 as a set of declarations. The analysis platform 232 may be configured to translate the set of declarations into a configuration file that may be implemented by the system component 310.

The solver 320 is configured to reason about what can or cannot work under the constraints. Results 322 of the solver may be implemented, by the analysis platform 232, in the test space to observe behaviors of the declarative digital twins 302 representing the system component 310 in a controlled environment. The results 322 may include solutions, explanations, test insights, and deployment test strategies.

As described, the user may interact with the analysis platform 232 via the UI. The UI may be configured to accept queries from the user at a client device. Given the ability to reason with the constraints, users may query the analysis platform 232 via the UI to find better solutions. The analysis platform 232 may be configured to generate a response based therefrom. By non-limiting example, the user may ask questions about system operations or input a request and/or query for insights, solutions, or the like. The analysis platform 232 may be configured to provide, in response to the user's query, insight about, for example, how to implement a plurality of flows together on a single piece of hardware, lowest power requirements for running the system, etc. By non-limiting example, the analysis platform 232 may determine that there is no solution based on the constraints and provide modification suggestions to enable a feasible solution. As another example, the user may ask the analysis platform 232 what issue in the system constraints are causing the system to fail.

Other questions a user may inquire about include, but are not limited to, a lowest power consumption feasible for running the system, how many CPU cores are needed at a minimum to support a deployment of the system, what test will produce a memory overflow, how many IoT users the system can support without negatively impacting a virtual reality (VR), augmented reality (AR), or mixed reality (MR), etc. Given the declarative approach to the facts and constraints of the digital twin, the solver 320 may analyze behaviors of the declarative digital twin 302 and provide the user with insightful explanations that may be used to further improvement/refine the declarative digital twin representation of the system.

The analysis platform 232 may be used to modify, add, or subtract one or more constraints based on, for example, the results 322 from the solver 320. The system component 310 may be continuously reevaluated based on new constraints and used for model refinement 324. Actual data from the system component 310 may be used as input to the analysis platform 232 to refine constraints and/or the declarative digital twin 302. For example, a test deployed by the analysis platform 232 may have indicated that the system would fail, but the actual system does not fail. The model refinement 324 may sample the system and use the sample data to compare against the declarative digital twin 302. The analysis platform 232 may analyze the comparison to determine how the actual system passed and improve the model (that is, the declarative digital twin 302). The comparison may result in identification of one or more invalid constraints which resulted in the discrepancy between the actual system and the declarative digital twin 302, new constraints that should be added to the declarative digital twin 302, or the like.

In some implementations, the solver 320 may generate new constraints based on the behavior of the physical system. The new constraints may be used to update or refine the model (that is, the declarative digital twin 302), which will reflect in the behavior of the physical system being modeled by the declarative digital twin 302. According to some embodiments, the user may not have all the information on a deployment, and therefore, only provides a partial specification of the deployment, resulting in a partial declarative digital twin 302. The model refinement 324 may be used to better match the physical system component 310 being modeled over time by, for example, including an update and/or addition of constraints for consideration in the declarative digital twin 302. The analysis platform 232 may continuously refine a partial declarative digital twin by adding more details (for example, constraints, functions, conditions, behaviors, or the like) about operations of the physical system based on actual data retrieved from the model refinement 324.

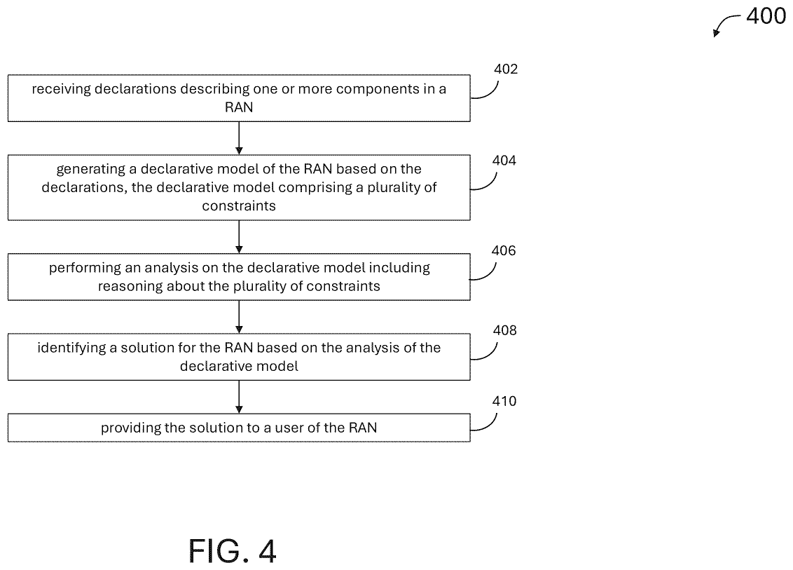

FIG. 4 illustrates an example flow diagram (for example, process 400) for implementing layered security in a RAN deployment, according to certain aspects of the disclosure. Further for explanatory purposes, the steps of the example process 400 are described herein as occurring in serial, or linearly. However, multiple instances of the example process 400 may occur in parallel.

At step 402, the process 400 may include receiving declarations or constraints describing one or more components in RAN. The one or more components may correspond to hardware, software, or a combination of hardware and software components. The one or more components may include, but are not limited to, RUs, DUs, CUs, switches, or the like. In some implementations, the declaration or constraints may be from a specification of the system provided by a user, network administrator, or user responsible for configuring network devices.

The declarations may include, for example, description of dependencies between RAN functions and flows for the one or more component(s) described in a domain specific language (for example, RDSL). The declarations may include hardware constraints comprising specifications on resources of the RAN, patterns of data movement, and hardware specific RAN metadata. The declaration may include metadata in, for example, YAML format about RAN functions (e.g., runtime, memory sizes, etc.). The declarations may comprise system level constraints including, but not limited to, QoS, timing, traffic models, latency, power, and security. According to embodiments, one or more of the declarations may include soft constraints or soft conditions for operating a system.

At step 404, the process 400 may include generating a declarative model of the RAN based on the declarations, the declarative model comprising a plurality of constraints. The declarative model may be a digital twin representing the RAN. In some implementations, the declarations are received in raw form. The process 400 may include translating the raw data to constraints, which make up the digital twin. According to embodiments, the process 400 may include receiving at least a subset of the plurality of constraints from the user of the RAN including, for example, deployment constraints. According to embodiments, the process 400 may include storing the plurality of constraints in a repository (e.g., a cloud-based repository or local repository) of known facts and constraints associated with the RAN.

At step 406, the process 400 may include performing an analysis on the declarative model, including reasoning about the plurality of constraints. The analysis may be performed by an AI reasoning tool configured to apply AI reasoning techniques to the declarative model to identify what, for example, tasks can or cannot work under the plurality of constraints, as well as provide reasons for why the tasks can or cannot work in a system.

According to embodiments, the analysis may include generating or adding additional constraints to the data lake based on, for example, queries entered by a user or the like. For example, the user may ask about power requirements for running the RAN. The analysis may result in one or more constraints generated for the declarative model in response to the power requirements question. This allows user queries to iteratively refine the declarative model (for example, adding constraints on power even though a power constraint was not previously declared). The AI reasoning tool may include, for example, a SAT solver or SMT solver. In some implementations, the analysis may be performed using ML/generative AI models.

At step 408, the process 400 may include identifying a solution for the RAN based on the analysis of the declarative model. The solution may include any one or combination of test insights, deployment test strategies, and explanations based therefrom. For example, the solution may include a pass or fail determination for a test implementation on the one or more components of the RAN based on the plurality of constraints. For example, the solution may include one or more constraints that represent conditions under which the test will pass or fail. For example, the solution may include reasons for the pass or failure of the test. According to embodiments, the process 400 may include searching, using the AI reasoning tool, through a test space corresponding to the RAN to identify an example of a feasible solution. According to embodiments, the solution may include the identified example.

At step 410, the process 400 may include providing the solution to a user of the RAN (or a UI corresponding to the user). As such, users are provided with not only where the RAN may pass or fail but also insights on why it will pass or fail. According to embodiments, the process 400 may include a post-processing step including generating a configuration file implementable by the one or more components in the RAN. The process 400 may further include deploying the configuration file in a test space associated with the RAN and using the resulting test data to refine the declarative model or output test insights based therefrom. According to embodiments, the process 400 may include refining the declarative model based on results of deploying the configuration file in the test space. According to embodiments, refining the declarative model may include at least one of adding a new constraint about operations of the RAN to the plurality of constraints or updating one of the plurality of constraints.

It is understood that the described systems and methods may be applied to any real-time system (RTS), and not just to RANs. The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software (including from, for example, analysis platform 232) that causes performance of the method(s).

### Hardware Overview

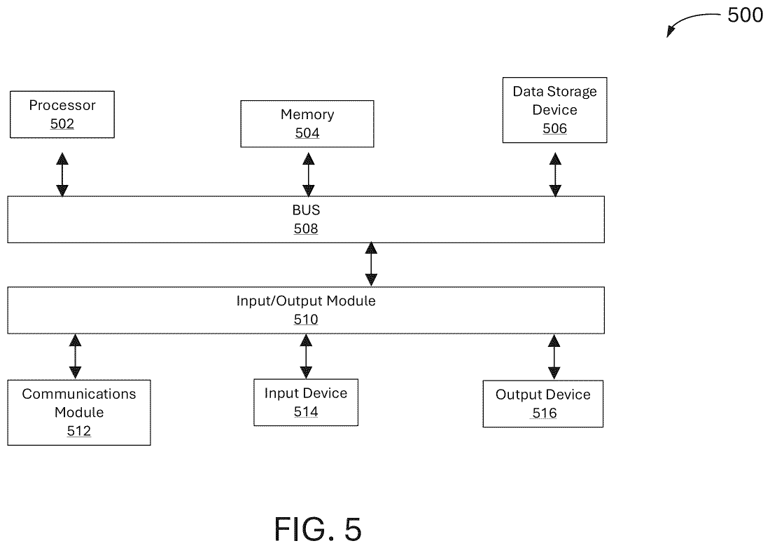

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities. Computer system 500 (for example, server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, for example, code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, that is, one or more modules of computer program instructions encoded on a computer-readable medium for execution by, or to control the operation of, the computer system 500, and according to any method well-known to those of skill in the art, including, but not limited to, computer languages such as data-oriented languages (for example, SQL, dBase), system languages (for example, C, Objective-C, C++, Assembly), architectural languages (for example, Java, .NET), and application languages (for example, PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, for example, a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, for example, visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, for example, such as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads and processes data, information may be read from the data and stored in a memory device, such as the memory 504. Additionally, data from the memory 504 servers accessed via a network, the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (that is, each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed:

1. A computer-implemented method, comprising:
receiving declarations describing one or more components in a radio access network (RAN);
generating a declarative model of the RAN based on the declarations, the declarative model comprising a plurality of constraints;
performing an analysis on the declarative model including reasoning about the plurality of constraints;
identifying a solution for the RAN based on the analysis of the declarative model; and
providing the solution to a user of the RAN.

2. The computer-implemented method of claim 1, wherein the declarations include at least metadata on RAN functions, a description of dependencies between the RAN functions and flows for the one or more components, and hardware constraints comprising specifications on resources of the RAN.

3. The computer-implemented method of claim 1, wherein performing the analysis includes using a Boolean satisfiability problem (SAT) or Satisfiability Modulo Theories (SMT) solver.

4. The computer-implemented method of claim 1, further comprising receiving at least a subset of the plurality of constraints from the user of the RAN, the subset including deployment constraints.

5. The computer-implemented method of claim 1, further comprising storing the plurality of constraints in a repository of known facts and constraints associated with the RAN.

6. The computer-implemented method of claim 1, further comprising:
searching, using artificial intelligence (AI) reasoning, through a test space corresponding to the RAN to identify an example of a feasible solution; and
providing the example of the feasible solution to the user of the RAN.

7. The computer-implemented method of claim 1, wherein the solution includes (i) a pass or fail determination for a test for the one or more components of the RAN based on the plurality of constraints, (ii) one or more constraints that represent conditions under which the test will pass or fail, and (iii) reasons for the pass or failure of the test.

8. The computer-implemented method of claim 1, further comprising:
generating a configuration file implementable by the one or more components in the RAN; and
deploying the configuration file in a test space associated with the RAN.

9. The computer-implemented method of claim 8, further comprising refining the declarative model based on results of deploying the configuration file in the test space, wherein refining the declarative model includes at least one of adding a new constraint about operations of the RAN to the plurality of constraints or updating one of the plurality of constraints.

10. A system, comprising:
a processor; and
a memory comprising instructions stored thereon, which when executed by the processor, causes the processor to perform:
receiving declarations describing one or more components in a radio access network (RAN);
generating a declarative model of the RAN based on the declarations, the declarative model comprising a plurality of constraints;
performing an analysis on the declarative model including reasoning about the plurality of constraints;
identifying a solution for the RAN based on the analysis of the declarative model; and
providing the solution to a user of the RAN.

11. The system of claim 10, wherein the declarations include at least metadata on RAN functions, a description of dependencies between the RAN functions and flows for the one or more components, and hardware constraints comprising specifications on resources of the RAN.

12. The system of claim 10, wherein performing the analysis includes using a Boolean satisfiability problem (SAT) or Satisfiability Modulo Theories (SMT) solver.

13. The system of claim 10, further comprising stored sequences of instructions, which when executed by the processor, cause the processor to perform receiving at least a subset of the plurality of constraints from the user of the RAN, the subset including deployment constraints.

14. The system of claim 10, further comprising stored sequences of instructions, which when executed by the processor, cause the processor to perform storing the plurality of constraints in a repository of known facts and constraints associated with the RAN.

15. The system of claim 10, further comprising stored sequences of instructions, which when executed by the processor, cause the processor to perform:
searching, using artificial intelligence (AI) reasoning, through a test space corresponding to the RAN to identify an example of a feasible solution; and
providing the example of the feasible solution to the user of the RAN.

16. The system of claim 10, wherein the solution includes (i) a pass or fail determination for a test for the one or more components of the RAN based on the plurality of constraints, (ii) one or more constraints that represent conditions under which the test will pass or fail, and (iii) reasons for the pass or failure of the test.

17. The system of claim 10, further comprising stored sequences of instructions, which when executed by the processor, cause the processor to perform:
generating a configuration file implementable by the one or more components in the RAN; and
deploying the configuration file in a test space associated with the RAN.

18. The system of claim 17, further comprising stored sequences of instructions, which when executed by the processor, cause the processor to perform refining the declarative model based on results of deploying the configuration file in the test space, wherein refining the declarative model includes at least one of adding a new constraint about operations of the RAN to the plurality of constraints or updating one of the plurality of constraints.

19. A non-transitory computer-readable storage medium comprising instructions stored thereon, which when executed by one or more processors, cause the one or more processors to perform operations, the operations comprising:
receiving declarations describing one or more components in a radio access network (RAN);
generating a declarative model of the RAN based on the declarations, the declarative model comprising a plurality of constraints;
performing an analysis on the declarative model including reasoning about the plurality of constraints;
identifying a solution for the RAN based on the analysis of the declarative model; and
providing the solution to a user of the RAN.

20. The non-transitory computer-readable storage medium of claim 19, further comprising stored instructions, which when executed by the processor, cause the processor to perform refining the declarative model based on results of deploying a configuration file in a test space, wherein refining the declarative model includes at least one of adding a new constraint about operations of the RAN to the plurality of constraints or updating one of the plurality of constraints.
